(19) United States
(12) Patent Application Publication
(10) Pub. No.: US 2008/0243291 A1
(43) Pub. Date: Oct. 2, 2008

(54) Method and system for assessing and diagnosing control loop performance

(75) Inventors: Joseph Ching Hua Lee, Singapore (SG); Sharad Vishwasrao, Singapore (SG); Emelin Ornelas, Caracas (VE); Naoya Kishimoto, Tokyo (JP); Tatsuhiko Imai, Tokyo (JP)

Correspondence Address: Edwards Angell Palmer & Dodge LLP, P.O. Box 55874, Boston, MA, 02205, US

(73) Assignee: Yokogawa Electric Corporation, Tokyo (JP)

(21) Appl. No.: 12/009,454

(22) Filed: Jan. 18, 2008

(30) Foreign Application Priority Data
Mar. 28, 2007 (SG) 200702340-1

(51) Int. Cl. G06F 17/00

(52) U.S. Cl. 700/110

(57) ABSTRACT

The invention is a system for assessing and diagnosing performance of a control loop, comprising a Data Collection Section which collects data of two parameters of the control loop for an installed valve. The data collected is processed in a Linear Regression Section to generate a linear regression. A User Setting Port is provided to define the tolerance band and the boundary points. The generated linear regression, together with the defined tolerance band and boundary points are processed in a Linear Approximation Section to generate an acceptable reference region.

### FIELD OF INVENTION

This invention is related to the assessment and diagnosis of a control loop for valve operation based on process and manipulated data.

### BACKGROUND OF THE INVENTION

Valves installed in a plant are controlled by control loops. FIG. 1 illustrates a schematic diagram of such a prior art setup. An instrument 100 for displaying a Process Variable (PV), for example flow rate, temperature or pressure, is monitored by a control loop 102. The control loop monitors the PV against a desired value or a setpoint 104, and outputs a Manipulated Variable (MV) to control the valve opening 106. This ensures that the valve is functioning properly and the PV is within specifications. The performance of the control loops must be maintained within optimal levels to realise the benefits of automation.

Typical control loop performance indices are used for detecting poorly performing control loops by comparing the controller performance against a user-defined benchmark, such as a minimum variance index. An example of the method of monitoring is illustrated in FIG. 2. For each control loop, data is collected and the performance indices are calculated. The calculated performance indices are compared against the benchmark for determining poor performing control loops. Then a diagnosis for the control loop is performed. In a control loop diagnosis, higher order statistics and spectral analysis are performed to provide an insight on the source of the poor performance.

Precious time and resources are required for such a diagnosis. Hence, there is a need for a method to improve the assessment and diagnosis of the control loops. In addition, prior methods do not consider other factors such as valve wear and tear, poor tuning, leakage and/or impulse line blocking which can affect the overall performance of the control loop.

Japanese patent publication number JP 02-150740 discloses a method for evaluating performance of a valve from its service life. This is done by calculating the differential pressure between the upstream and downstream side pressure of the valve and cavitation number, and finding the coordinate point of the opening of the valve and cavitation number. The calculation is based on the downstream side pressure and atmospheric pressure. The position and time, corresponding to the coordinate point, are integrated to find a life index. The service life of the valve is evaluated based on the life index.

The applicants' prior invention, Japanese patent number JP 3219116 provides an abnormality diagnostic method by collecting PV as data for a desired range. The data is expressed in a linear function against time by using the least squares method. Standard deviations between the linear function and the collected dated are obtained and the maximum data is set to be a common standard deviation value and is used to establish the respective polygonal line functions of an upper and lower limits of the desired range. When a measured data does not exist in the range between the polygonal line functions, the process is diagnosed to be abnormal and a signal is output.

This method only monitors the PV over a duration or period of time and does not take into consideration the other dynamic elements in the control loop such as a control valve movement in which wear and tear of the actuator plays a key role in affecting the PV.

The objective of the current invention is to provide a true dynamic representation of the entire control loop performance and diagnosis by taking into account all the factors which affect the characteristics of all the elements in the loop.

### SUMMARY OF THE INVENTION

The invention is a system for assessing and diagnosing a control loop performance, comprising a Data Collection Section which collects data of two parameters of the control loop for an installed valve during a steady state. The data collected during the steady state operation, which can be referred as the Reference Data, is processed in a Linear Regression Section to generate a linear regression. A User Setting Port is provided to define the tolerance band and the boundary points, which are the minimum and maximum operating points. The generated linear regression, together with the defined tolerance band and boundary points are processed in a Linear Approximation Section to generate an acceptable reference region.

### BRIEF DESCRIPTION OF THE DRAWING

FIG. 1 illustrates a schematic diagram of a prior art setup of a control loop for a valve.

FIG. 2 illustrates a typical control loop assessment and diagnosis methodology in the prior art.

FIG. 3 illustrates a preferred system of the invention.

FIGS. 4A, 4B and 4C illustrate an example of the generation of the reference region in the invention.

FIG. 5 illustrates a comparison of data against the reference region.

FIGS. 6A and 6B illustrate a flowchart of the invention.

FIGS. 7A and 7B illustrate examples of signatures of control loops used for diagnosis in the current invention.

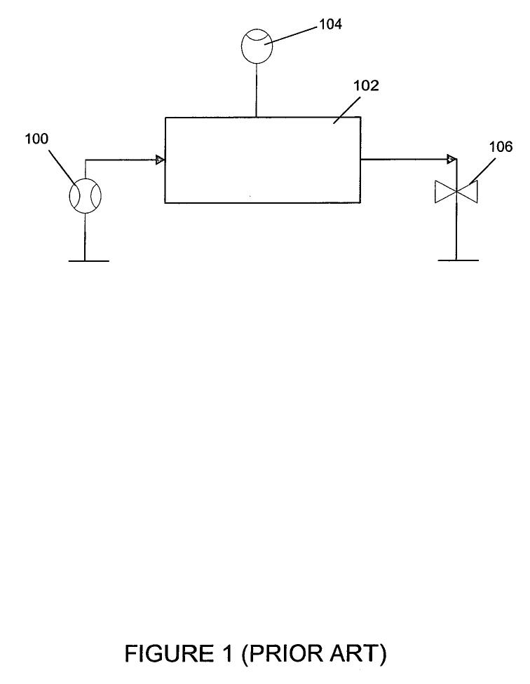

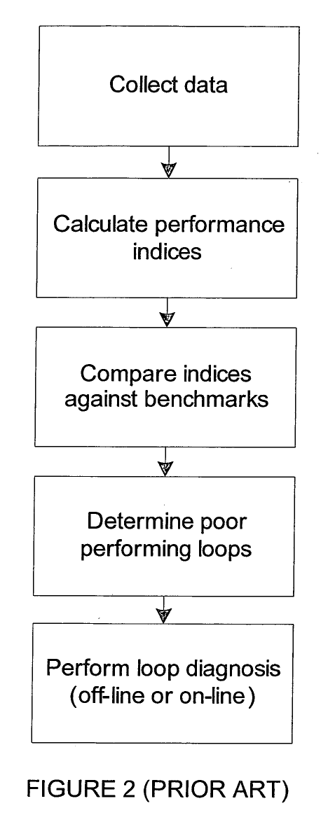

### DETAILED DESCRIPTION OF THE PREFERRED EMBODIMENT

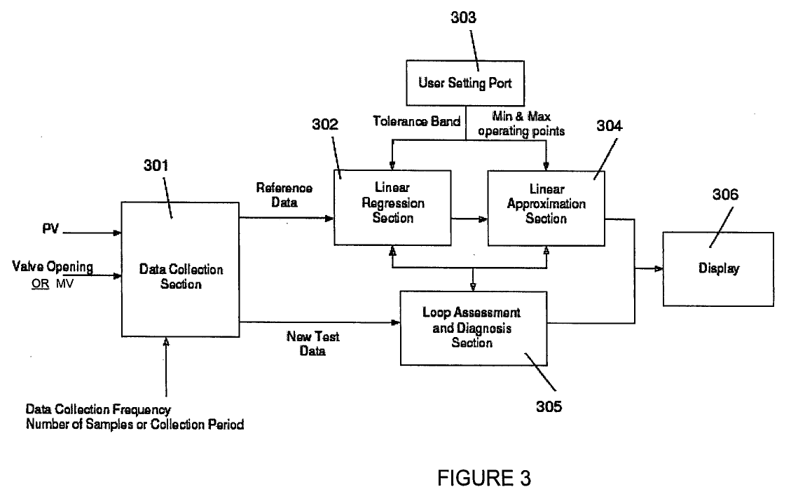

A preferred embodiment of the invention is a system for applying, assessing and diagnosing a control loop performance as illustrated in FIG. 3. A Data Collection Section 301 collects data of at least two parameters of the control loop for an installed valve during steady state operation. The first parameter is the Process Variable (PV), which is being monitored and inputted to the control loop. The second parameter is the valve opening. For a valve opening controlled by a conventional valve, which is not part of the control loop, the control loop outputs a Manipulated Variable (MV) based on a setpoint. The valve opening can be derived from the MV and the valve characteristic curve. In this case, the second parameter is the MV.

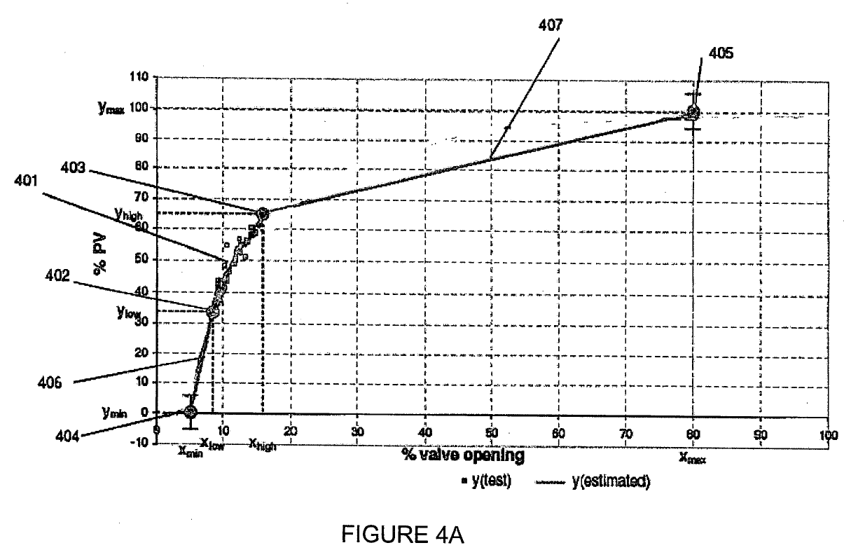

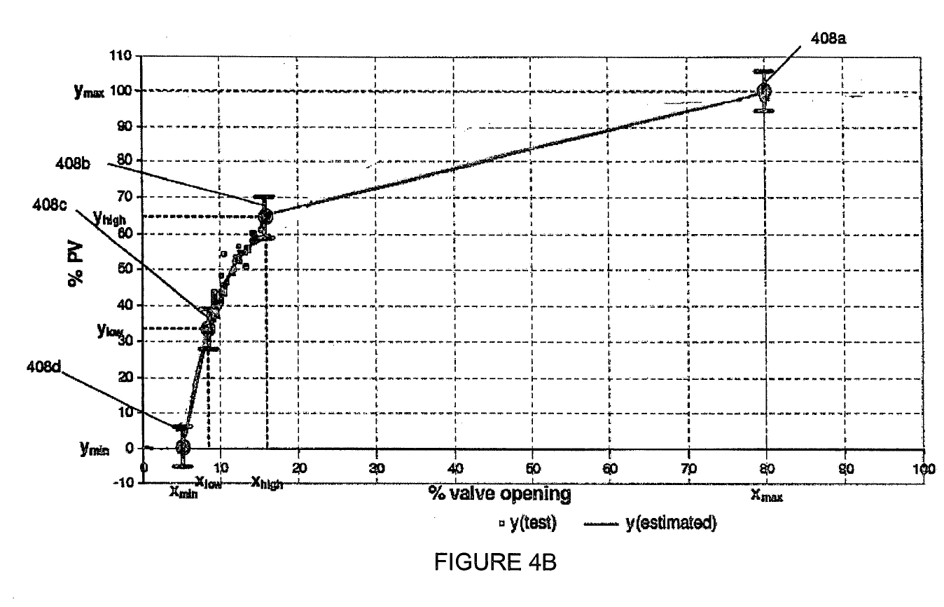

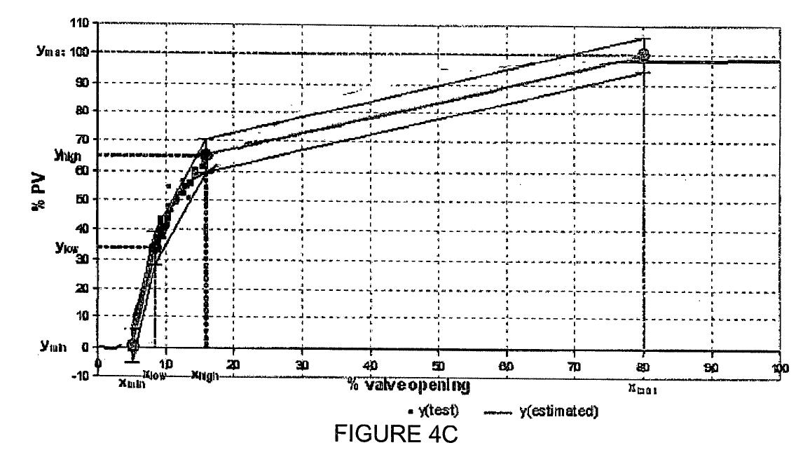

In order to ensure that sufficient data is collected for establishing a reference region which is representative of the installed valve characteristic, the valve opening is varied to obtain the corresponding PV. Alternatively, the setpoint is varied to obtain the corresponding MV. The data collected during the steady state operation, which can be referred as the Reference Data, is processed in a Linear Regression Section 302 to generate a linear regression line. FIGS. 4A, 4B and 4C illustrate the generation of the established reference region. The x-axis is the parameter of the valve, which in the preferred embodiment, is the valve opening. The y-axis is the PV. The generated linear regression line is plotted as line 401 having a lower end point (x_{low}, y_{low}) 402 and a higher end point (x_{high}, y_{high}) 403.

The linear regression line is generated based on an equation in the form:

y=m·x+b

where:

$$m = \frac{n ( \sum xy ) - ( \sum x ) ( \sum y )}{n ( \sum {x}^{2} ) - {( \sum x )}^{2}} ;$$

the slope of the line,
x and y are parameters defined in the control loop;
n is the count for the number of data sets (x₁, y₁), (x₂, y₂), . . . , (xₙ, yₙ);
an interception with the y-axis,

$$b = \frac{( \sum y ) - m ( \sum x )}{n} ;$$

Σx=x₁+x₂+ . . . +xₙ;

Σy=y₁+y₂+ . . . yₙ;

Σxy=x₁y₁+x₂y₂+ . . . +xₙyₙ;

Σx²=x₁²+x₂²+ . . . +xₙ².

A User Setting Port 303 in FIG. 3 is provided to define the tolerance band and the boundary points, which are the minimum and maximum operating points. In FIG. 4, the minimum operating point (xₘᵢₙ, yₘᵢₙ) and maximum operating point (xₘₐₓ, yₘₐₓ) are represented on the graphs by the reference numerals 404 and 405 respectively.

In a Linear Approximation Section 304 of FIG. 3, linear approximation is performed to interpolate the linear regression line to the maximum and minimum operating points. As shown in FIG. 4A, by using the lower operating point 402 and the minimum operating point 404, a line 406 is interpolated from the lower operating point to the minimum operating point. Similarly, a line 407 is interpolated from the upper operating point 403 to the maximum operating point 405.

Taking into consideration the set of boundary values, (xₘᵢₙ, yₘᵢₙ), which define the minimum values and (x_{low}, y_{low}) as the set of values which define the lowest data collected, the interpolated line 406 is formed from an equation in the form

y=m·x+b
if xₘᵢₙ equals to 0,
   the interception of the line with the y-axis, b=0; and
   the slope of the line,

$$m = \frac{{y}_{low}}{{x}_{low}} ,$$

if xₘᵢₙ does not equal to 0,

$$b = \frac{{y}_{low}}{( 1 - \frac{{x}_{low}}{{x}_{min}} )} ;$$

the interception of the line with the y-axis, and

$$m = \frac{( {y}_{low} - b )}{{x}_{low}} .$$

the slope of the line,

Secondly, another line is generated using a set of boundary values (xₘₐₓ, yₘₐₓ) which defines the maximum values, and a set of values (x_{high}, y_{high}) which defines the upper limits of the tolerance band based on an equation in the form

y=m·x+b
where x equals to xₘₐₓ,
   the interception of the line with the y-axis,

$$b = [ {y}_{high} - \frac{{y}_{max} \times {x}_{high}}{{x}_{max}} ] / [ 1 - \frac{{x}_{high}}{{x}_{max}} ] ;$$

and

$$m = \frac{( {y}_{high} - b )}{{x}_{high}} .$$

the slope of the line,

The reference line formed by the lines 406, 401 and 407 illustrates the characteristic of the valve.

The Linear Approximation Section further defines a reference region by applying the user-defined tolerance band around the reference line. In an example, β represents a user-defined tolerance band. A value of β*stdev(X) is applied to the maximum operating point, higher end point, lower end point and minimum operating point as represented in FIG. 4B by 408a, 408b, 480c and 408d respectively and the points are joined forming the reference region 409 in FIG. 4C.

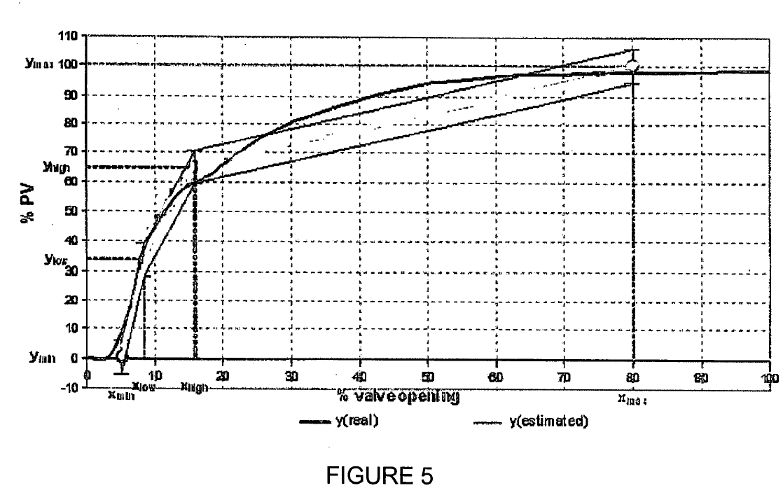

When the reference region is generated, referring back to FIG. 3, the Data Collection Section continues with data collection for assessment and diagnosis of the control loop. The data collected are referred to as New Test Data. The New Test Data is processed in a Loop Assessment and Diagnosis Section 305, Linear Regression Section 302 and Linear Approximation Section 304. The results processed in the sections are displayed on a graphical user interface display 306. An example of the display when the New Test Data is fitted to the reference region is shown in FIG. 5. The new data 501 is compared against the reference region 409.

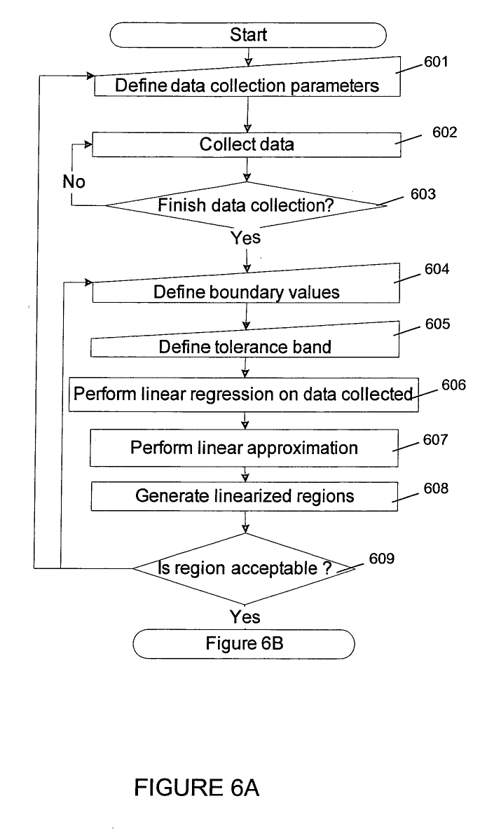

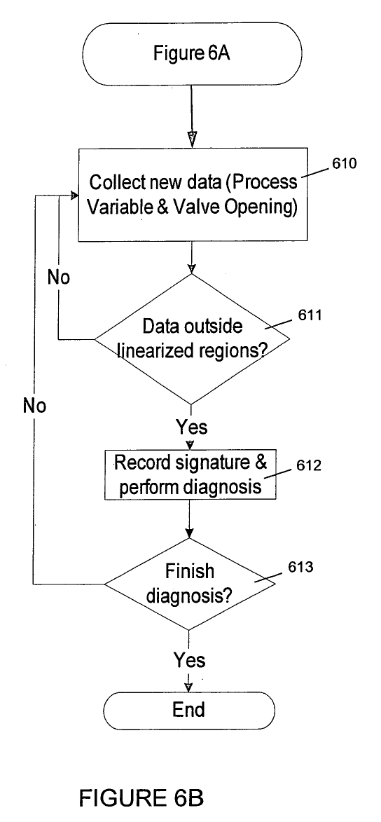

The invention provides a method illustrated in FIGS. 6A and 6B for assessing and diagnosing a control loop performance including the step 601 of defining two parameters for data collection, step 602 for collecting data for the defined parameters of the control loop during a steady state operation. In a control loop for installed valve, the parameters are likely to be the Process Variable (PV) and the Manipulated Variable (MV) or valve opening for a smart valve positioner which is not part of the control loop.

Step 603 determines if the data collection is completed. If not, data collection is done until the required amount of data is collected. This will ensure that sufficient data samples are collected for a reliable representation of the steady state operation. The amount of data to be collected is determined either by specifying the number of data samples for collection, or the period of data collection. In order to obtain data samples, this is done preferably by varying the valve opening or setpoint which changes the values for the PV or MV respectively. For example, a setpoint with the control loop in a preferred mode, or a controller output with the control loop in a manual mode, when varied, result in data sets of PV and the respective valve opening or MV. However, the varied setpoints and controller outputs must be within the pre-defined specifications for the steady state operation.

When the required data collection is finished, a reference region of data is established as previously described for the system. The reference region is representative of the installed valve characteristics during the different states of operations. This is done firstly in the step 604 by defining at least one set of boundary values. Preferably two set of boundary values are defined, the minimum operating point as the lower boundary and the higher operating point as the higher boundary. In step 605, a tolerance band is defined. The boundary values and tolerance band can be defined by allowing a user to enter the values manually or applying pre-defined values.

In step 606, a linear regression is performed on the data collected to generate a steady state region. In a linear approximation step 607, interpolation is performed from the higher end point of the collected data to the maximum operating value and from the lower end point to the minimum operating value to generate a reference line. In step 608, the tolerance band is applied to the reference line to generate a linearized region.

In order to realise this invention, the following assumptions are considered. A substantially linear relationship between the parameters, the PV and valve opening or MV, can be obtained around the steady state operating region; and a substantially linear relationship is assumed between the limits of the steady state operating region and the boundary limits, which are the maximum and minimum operating points.

When the reference region is generated, preferably the generated region is determined if it is acceptable in step 609. If it is not acceptable, the steps of generating the reference region are repeated from defining the boundary values and the tolerance band. These steps are repeated until generated region is acceptable.

After an acceptable reference region is generated, the assessment and diagnosis of the control loop can be activated. This is done by collecting new data in step 610 and comparing against the data within the reference region, thereby assessing and diagnosing the control loop performance. This method of assessing and diagnosing the control loop performance eliminates the step of taking the control loop off-line for special tests. Since the control loop does not have to be put in an off-line mode, because data for any predefined parameters can be collected while the control loop is in on-line, a continuous assessment is possible.

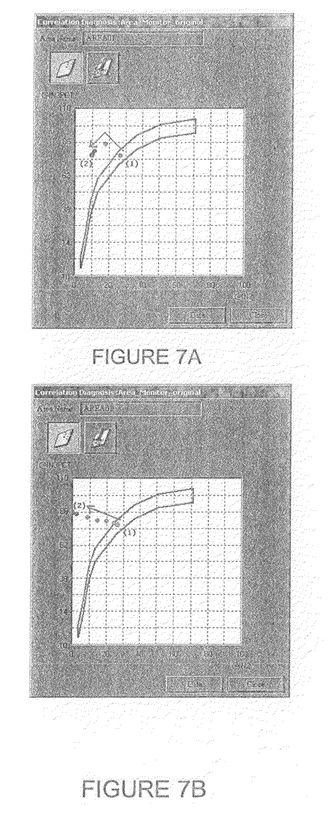

For each data set collected, the assessment and diagnosis include determining if the data is out of the reference region in step 611. If the data set is out of the reference region, the signature of the data set is recorded and a diagnosis is performed in step 612. Examples of signatures of data sets are illustrated in FIGS. 7A and 7B. There is a check in step 613 to determine if the diagnosis is finished. If the diagnosis is not finished, the steps of collecting new data to performing the diagnosis will be repeated until the diagnosis is determined to be completed.

In the invention, the control loop in addition to the valve performance is being monitored by collecting data for both the PV and the valve opening or MV. The process value is not only monitored over time, the valve performance is also taken into consideration. Hence, the collected data is a true dynamic representation of the entire control loop performance. The signature of the data collected when plotted against the reference region allows much more efficient troubleshooting. For example FIGS. 7A and 7B illustrate data signatures for pipe leakage and impulse line blocking respectively.

With the application of the invention, there is no disruption to the control loop which is being assessed and diagnosed. The control loop performance can be continuously monitored and diagnosed to efficiently identify poorly or underperforming control loops. With such a clear view of the performance of the control loops, preventive maintenance plans can be prioritised and deployed in more efficient manner.

Advantageously, this reduces the need for performing offline tests on the control loop for the valves which affects the productivity and performance of a plant having control loops.

We claim:

1. A system for assessing and diagnosing performance of a control loop for a valve including:
(a) a data collecting means for collecting two parameters of the control loop during a steady state operation;
(b) a linear regression means and a linear approximation means for establishing at least one reference region of data;
(c) a user setting means for defining a tolerance band and the boundary values of the two parameters;
(d) an assessment and diagnosis means for assessing and diagnosing new data collected by the data collecting means; and
(e) a display means for displaying the results of the assessment and diagnosis.

2. A method for assessing and diagnosing performance of a control loop for a valve including the steps of:
(a) collecting data of two parameters of the control loop during a steady state operation;
(b) establishing at least one reference region of data;
(c) collecting new data for the parameters; and
(d) comparing new data against the reference region,
thereby assessing and diagnosing the control loop performance.

3. A method as claimed in claim 2 wherein the step of collecting data during a steady state operation includes the steps of:
defining the parameters for data collection; and
determining the amount of data collection by either
specifying the number of data samples to be collected; or
specifying the period for data collection.

4. A method as claimed in claim 2 wherein the step of establishing at least one reference region of data around the steady state operation includes the step of performing a linear regression on the collected data.

5. A method as claimed in claim 4 in which prior to the step of performing a linear regression, further includes the steps of:
defining at least one set of boundary values for the parameters; and
defining a tolerance band.

6. A method as claimed in claim 5 further including the steps of
performing a linear approximation between the steady state region and the defined boundary values to generate a reference line of data, and
applying the tolerance band to the reference line, thereby generating a reference region.

7. A method as claimed in claim 4 wherein the step of performing a linear regression is based on an equation in the form
y=m·x+b
where:
$$m = \frac{n ( \sum xy ) - ( \sum x ) ( \sum y )}{n ( \sum {x}^{2} ) - {( \sum x )}^{2}} ;$$
x, y=parameters defined in the control loop;
n=number of data points (x₁, y₁), (x₂, y₂), . . . , (xₙ, yₙ).
$$b = \frac{( \sum y ) - m ( \sum x )}{n}$$
$$\sum x = {x}_{1} + {x}_{2} + … + {x}_{n}$$
$$\sum y = {y}_{1} + {y}_{2} + … + {y}_{n}$$
$$\sum xy = {x}_{1} {y}_{1} + {x}_{2} {y}_{2} + … + {x}_{n} {y}_{n}$$
$$\sum {x}^{2} = {x}_{1}^{2} + {x}_{2}^{2} + … + {x}_{n}^{2} .$$

8. A method as claimed in claim 6 wherein the step of generating a reference region of data further includes the steps of
generating a second line using a set of boundary values defining the minimum values and a set of values defining the lower limits of the tolerance band based on an equation in the form
y=m·x+b
wherein xₘᵢₙ=0,
b=0; and
$$m = \frac{{y}_{low}}{{x}_{low}} ,$$
wherein xₘᵢₙ≠0
$$b = \frac{{y}_{low}}{( 1 - \frac{{x}_{low}}{{x}_{min}} )} ; and$$
$$m = \frac{( {y}_{low} - b )}{{x}_{low}} ,$$
where (xₘᵢₙ, yₘᵢₙ) is a set of boundary values defining the minimum values;
(x_{low}, y_{low}) is a set of values defining the lowest data collected;
and
generating a third line using a set of boundary values defining the maximum values and a set of values defining the upper limits of the tolerance band based on an equation in the form
y=m·x+b
wherein x=xₘₐₓ,
$$b = [ {y}_{high} - \frac{{y}_{max} \times {x}_{high}}{{x}_{max}} ] / [ 1 - \frac{{x}_{high}}{{x}_{max}} ] ; and$$
$$m = \frac{( {y}_{high} - b )}{{x}_{high}} ,$$
where (xₘₐₓ, yₘₐₓ) is a set of boundary values defining the maximum values;
(x_{high}, y_{high}) is a set of values defining the highest data collected.

9. A method as claimed in claim 6 further including the step of:
determining if the generated reference region is acceptable, wherein if the generated reference region is not acceptable, the steps of generating the reference region are repeated from the step of defining the boundary values.

10. A method as claimed in claim 2 wherein the step of comparing new data against the reference region, for each data collected includes the steps of:
determining if the data is out of the reference region;
wherein the data is out of the reference region, the method further includes the steps of:
recording the data;
performing a diagnosis; and
determining if the diagnosis is completed.

11. A method as claimed in claim 3 wherein the first parameter is a process value and the second parameter is a valve opening.

12. A method as claimed in claim 3 wherein the first parameter is a process valve and the second parameter is an output value of the control loop.

13. A method as claimed in claim 11 further including the steps of
varying the second parameter during the data collection; and
obtaining the first parameter corresponding to the varied second parameter.

14. A method as claimed in claim 12, wherein the control loop has a predefined setpoint, further including the steps of
varying the predefined setpoint, and
obtaining the corresponding first and second parameters during the data collection.
